(19) United States
(12) Patent Application Publication
(10) Pub. No.: US 2015/0230634 A1
(43) Pub. Date: Aug. 20, 2015

(54) Wherever Garden

(71) Applicant: Jeffrey Mark Christlieb, Fort Lauderdale, FL (US)

(72) Inventor: Jeffrey Mark Christlieb, Fort Lauderdale, FL (US)

(21) Appl. No.: 14/537,525

(22) Filed: Nov. 10, 2014

Related U.S. Application Data
(60) Provisional application No. 61/902,647, filed on Nov. 11, 2013.

(51) Int. Cl. A47G 7/04; F16M 13/02

(52) U.S. Cl. CPC A47G 7/044; F16M 13/02

(57) ABSTRACT

A planter mounting device has a back member integrated with a perpendicularly oriented intermediate member. This intermediate member interfaces with a tongue like mounting plate at a curved surface. This closed surface is utilized to place a planter, vase, or pot against it thereby providing horizontal support therefore. Another vertically oriented tongue is disposed at the top portion of the back member; this slides under the depression or contoured indentation formed by the edge of a pot or plant. Utilizing plastic ties, screws, or a strip of material a pot, planter or vase can be mounted on a tree, post or plastic support. A unique mounting system is created from a series of T Joints, connecting members and elbow joints.

### FIELD OF THE INVENTION

The present invention relates to the display of plants in pots and novelties thereof. More particularly, the present invention relates to various mechanisms by which a plant within a pot is displayed in non-traditional places.

### BACKGROUND OF THE INVENTION

### Nylon Attachment System

FIG. 1A presents a typical carrying system of plastic engagement between two strips of material. A typical carrying container such as a backpack or fanny pack has two strips of material, typically nylon, that are attached to either side of the container. These two strips end in members that when brought together form a removable connection point; the first strip ends in an insertion member IM whilst the second strip ends in a receiving member. To activate the connection, a first insertion member IM is placed within the confines of the receiving member RM as the plastic components of the insertion member therein flex to engage the mechanical realities of the receiving member. Pressing against the sides of the insertion member IM through holes on either side of the receiving member disconnects the two components thereby disengaging the two strips of material and permitting the user to remove the container from his or her body. It should be readily apparent that the nylon strip is wrapped around a transverse post in the body of the buckle device IM and tightened according to well known usage of these devices. FIG. 1B shows a closeup of a receiving member RM having and the insertion member both having a nylon strip about the central post. The receiving member nylon strip folds back and is sewn to the nylon strip thereby permanently attaching it to the strip.

### Plastic Ties

In its common form, the nylon cable tie consists of a strip section with triangular teeth that slope in one direction. The head of the cable tie has a slot with a flexible pawl that irreversibly rides up the slope of these teeth when the strip is inserted. The pawl engages the backside of these teeth to stop removal of the strip.

### Planters & Pots

Many types of plants are cultivated to improve the image of an area or region. The use of plants for aesthetic purposes about the home or surrounding businesses provides an appealing break in the modern concrete jungle. Plants have been placed in containers such as vases or pots for time immemorial and new ways of presenting them are rarely found. Recently, a strip of biodegradable material or “rollout flower” has been introduced that has embedded flower seeds therein; thus, a user need only roll out the strip of material upon some top soil and one has a complete nearly instant flower bed. Whilst this is a innovative solution, it does not provide a way for planting and displaying plants and flowers about the trunk of trees or poles.

Thus, there needs to be a solution that overcomes this deficiency.

### SUMMARY OF THE INVENTION

The present invention overcomes the deficiencies of the known art and the problems that remain unsolved by providing an apparatus in various embodiments following.

A planter mounting device comprising:
a back member integrated perpendicularly with
a support member having
   an intermediate member and
   a mounting plate such that the intermediate member connects the back member to the mounting plate.
      In another aspect, further comprising:
a first perforation from a side of the back member to another side of the back member.
   In another aspect, further comprising:
a second perforation from a side of the back member to another side of the back member.
   In another aspect, further comprising:
a first hole from a front surface of the back member to a back surface of the back member.
   In another aspect, further comprising:
a second hole from a front surface of the back member to a back surface of the back member.
   In another aspect, further comprising:
a first hole from a front surface of the back member to a back surface of the back member disposed underneath the first perforation.
   In another aspect, further comprising:
a second perforation from a side of the back member to another side of the back member disposed underneath the first hole.
   In another aspect, further comprising:
a second hole from a front surface of the back member to a back surface of the back member disposed underneath the second perforation.
   In another aspect, further comprising:
a tongue extending out from a top of the back member.
   In another aspect, wherein the junction between the mounting plate and the intermediate member comprises a curved surface.
   In another aspect, wherein the junction between the mounting plate and the intermediate member comprises a curved surface.
   In another aspect, wherein the mounting plate integrates with the intermediate member along an edge of the intermediate member that also forms a bottom edge of a curved surface disposed between the mounting plate and the intermediate member.

A planting system comprising:
a central T joint connected to
   two connection members that are each in turn singly connected to
one of two T joints that are each connected to another connection member thus forming another four connection members that end in an elbow joint at the opposite side of each another four connection members.

A mounting system comprising:
a back member having
   a front face
   a back face
   and two oppositely disposed side faces all integrally formed together wherein the back member has a first side face to side face perforation and is formed integrally with
a mount support therein.
   In another aspect, a second perforation from one side face to another disposed in the back member.
   In another aspect, an intermediate member integral with the back member.
   In another aspect, a mount plate integral with the intermediate member.
   In another aspect, a back surface integral with and disposed between the mount plate and the intermediate member.
   In another aspect, an back concave surface integral with the back member.
   In another aspect, an mount plate integral with the back member.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1A presents a prior art typical carrying system of plastic engagement between two strips of material. FIG. 1B represents a closeup view of a prior art system of engagement of FIG. 1A.

FIG. 2 presents a set of isometric views of a plant mounting device in an embodiment of the Wherever Garden system.

FIG. 3 presents an isometric view of a standalone planting system in an embodiment of the Wherever Garden System.

FIG. 4A presents an embodiment of the Wherever Garden System as applied to the trunk of a tree.

FIG. 4B presents an embodiment of the Wherever Garden System standalone system using a plastic tie threaded through the smaller aperture in the side edges of the plant mounting device.

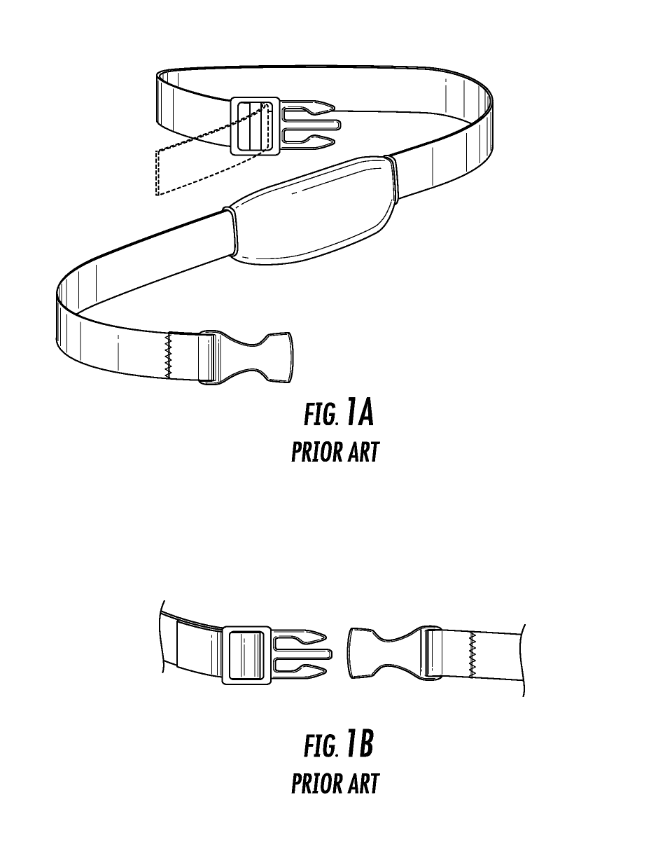

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in each figure. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

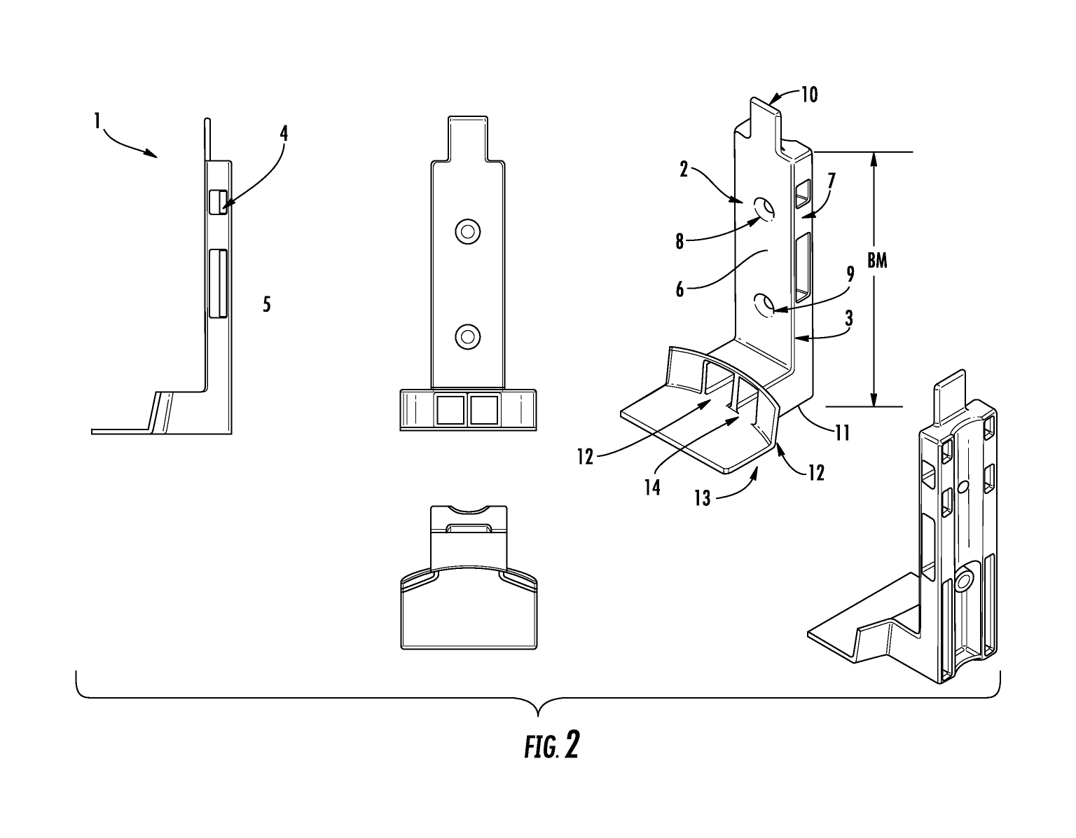

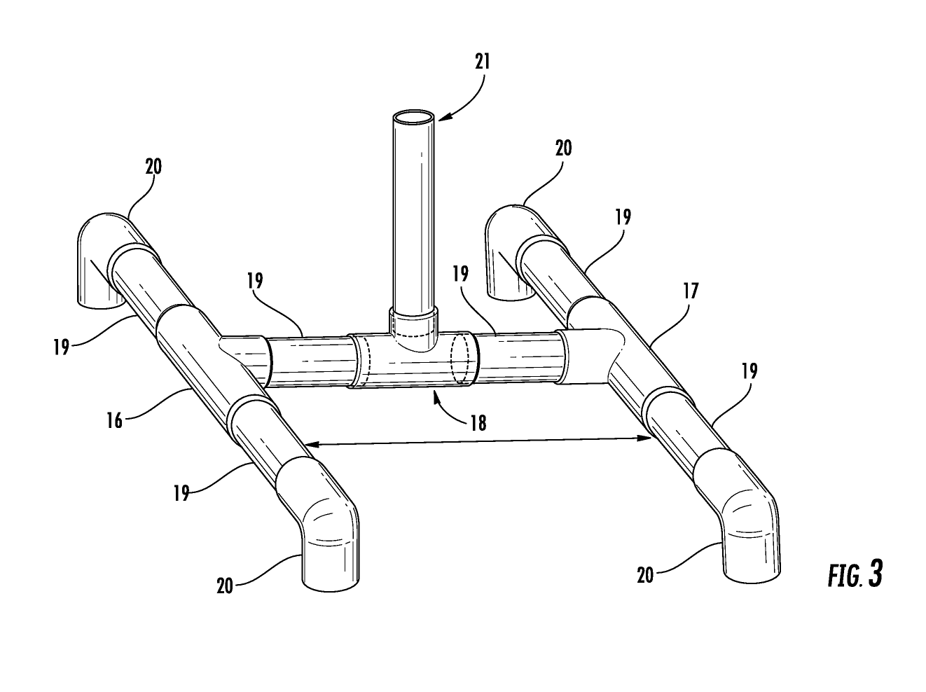

FIG. 2 presents an isometric view of a plant mounting device 1 in an embodiment of the Wherever Garden system. The plant mounting device 1 is made of two main components, an elongated rectangular back member BM and a mount support MS as well as several other simple structures that are defined in the following; it should be understood that the parts herein are made from plastic such as PVC or any convenient rigid plastic material. First, the elongated back member has two narrow edges forming a left edge 2 and a right edge 3 as well as a front face 6 and a back face 7 all integrated as one piece. The left 2 and right edges 3 have a small side to side perforation 4 above a larger side to side perforation 5 that completely transits from one edge to another. The front surface 6 has front to back surface 7 round perforations for the optional mounting of screws therein. The first such round perforation 8 is disposed between the two side to side perforations 4, 5 and the second round perforation 9 is underneath the second side to side perforation 5. These perforations narrow as they proceed from the front surface 6 down into the body of the back member so as to engage the head of the optional screws.

A tongue 10 is found at the top of the elongated rectangular back member BM formed by the edges 2, 3 and front surface 6. This tongue juts out parallel to the front surface 6 of the body of the elongated rectangular back member and is thinner and narrower than it. To use the device, a user inserts the curved underside of a rim that forms a circumferential overhang in a pot thereby hanging the pot rim on this tongue 10 whilst resting the bottom of the pot on the mounting support MS. At the opposite end of the rectangular back member is a mount support structure MS; this mount support MS is integral with the back member BM and perpendicular to it in the direction of away from the back surface 7 and towards the front surface 6 and outwards in that direction. This mount support structure MS is formed from an intermediate support member 11, a planter or pot back surface 12 and a planter or pot bottom support plate 13.

The intermediate support member 11 is a short (in comparison to the elongated back member BM) member of similar width of and height as the back member is deep (that is the distance between the front and back surfaces 6,7) that ends in the planter or pot back surface 12 and a planter or pot bottom support plate 13. The back surface 12 is a curved concave face that is utilized to abut the lower surface of a planter or pot placed upon the bottom support plate 13. It is this plate 13 that juts out like a thin tongue from the bottom edge of the back surface 12. Further, it should be apparent that the back surface 12 and the plate 13 are wider than the intermediate member 11. Finally, various vacant spaces 14 are formed in the back surface 12 to limit the amount of material used in the manufacture of the device. A spacer 15 is found to support the underside of a top face of the intermediate member 11 towards the inside bottom face of the intermediate member. Next, there is a central concave longitudinal surface in the back surface 7 of the back member BM that extends only through a portion of the back surface from right to left. Further, this central concave surface runs down only a portion of the longest dimension of the BM being broken by a cutout that conserves material space. The edge where the BM and MS unite is also curved as shown in the drawing. There are various cutouts shown in the back thereof and these can optionally be filled in thereby providing a single solid item with a curved surface running down the back of the BM.

FIG. 3 presents an isometric view of a standalone planting system in an embodiment of the Wherever Garden System. A standalone planting system is shown in the figure as a series of PVC connected members including T joints 16, 17, 18, connecting members 19, 21 and elbow joints 20. The T joints 16, 17, 18, and elbow joints 20 are standard components found in any hardware store; the connecting members 19 were modified from existing PVC pipe and are to be standardized when all the aforementioned components are sold in a kit. A central T joint 18 forms the core device for attaching all of the other PVC components. Two connection members 19 are inserted at either end of the T joint 18 such that these 19 are each connected at their opposite ends with another T joint 16, 17. The two other openings of each of these T joints 16, 17 are filled with another side of other connecting members 19. The free end of each of these four connecting member 19 are inserted in an elbow joint 20 that forms the feet of the entire system. Finally, a central stand connecting member 21 is inserted in the remaining aperture of the central T joint that has been oriented in such a fashion that the connecting member is vertically disposed.

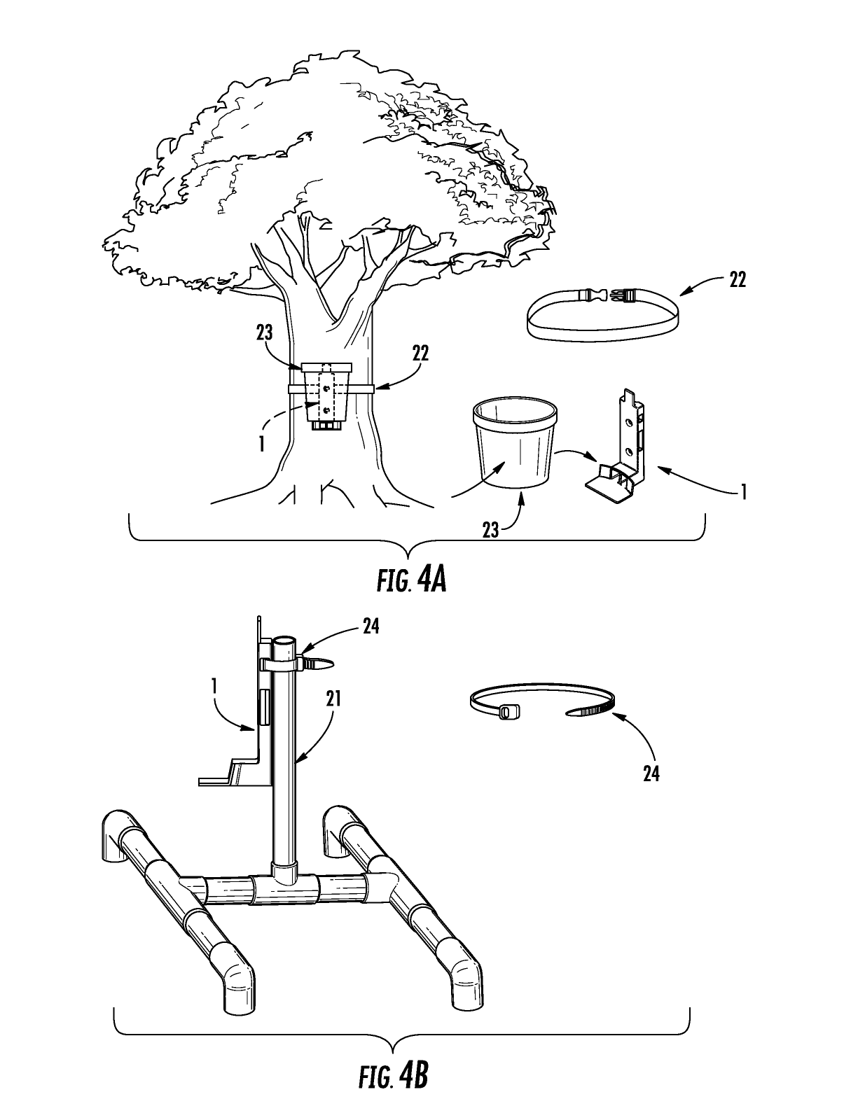

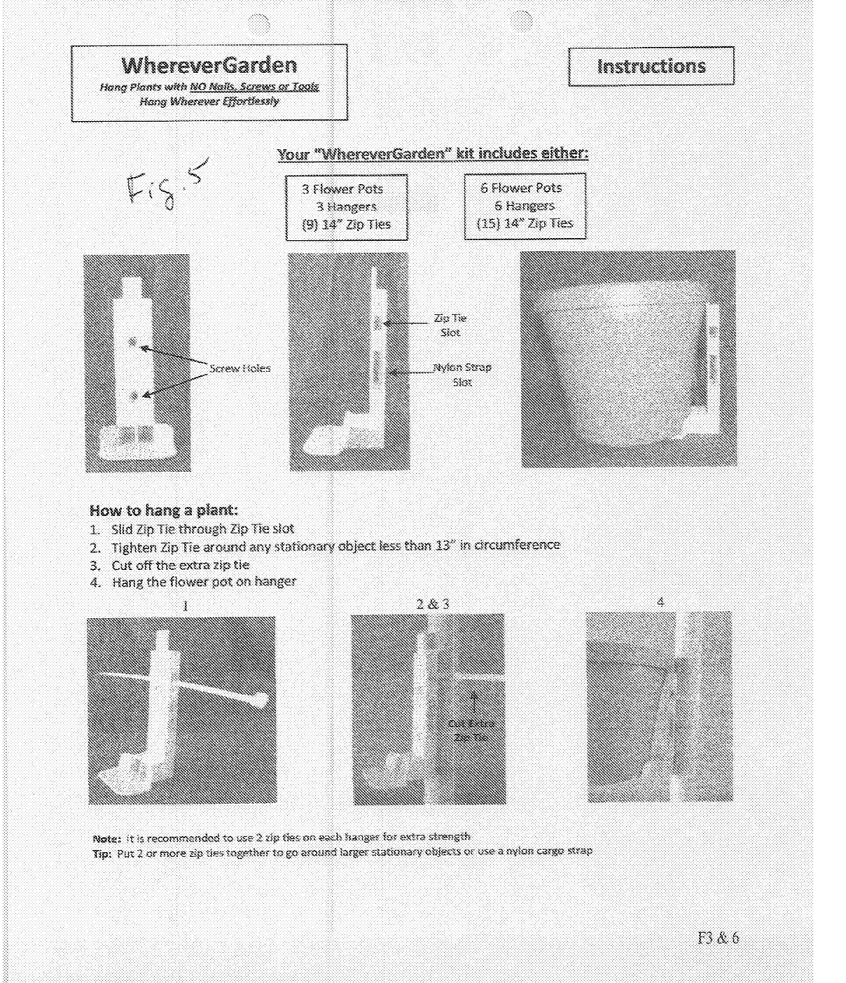

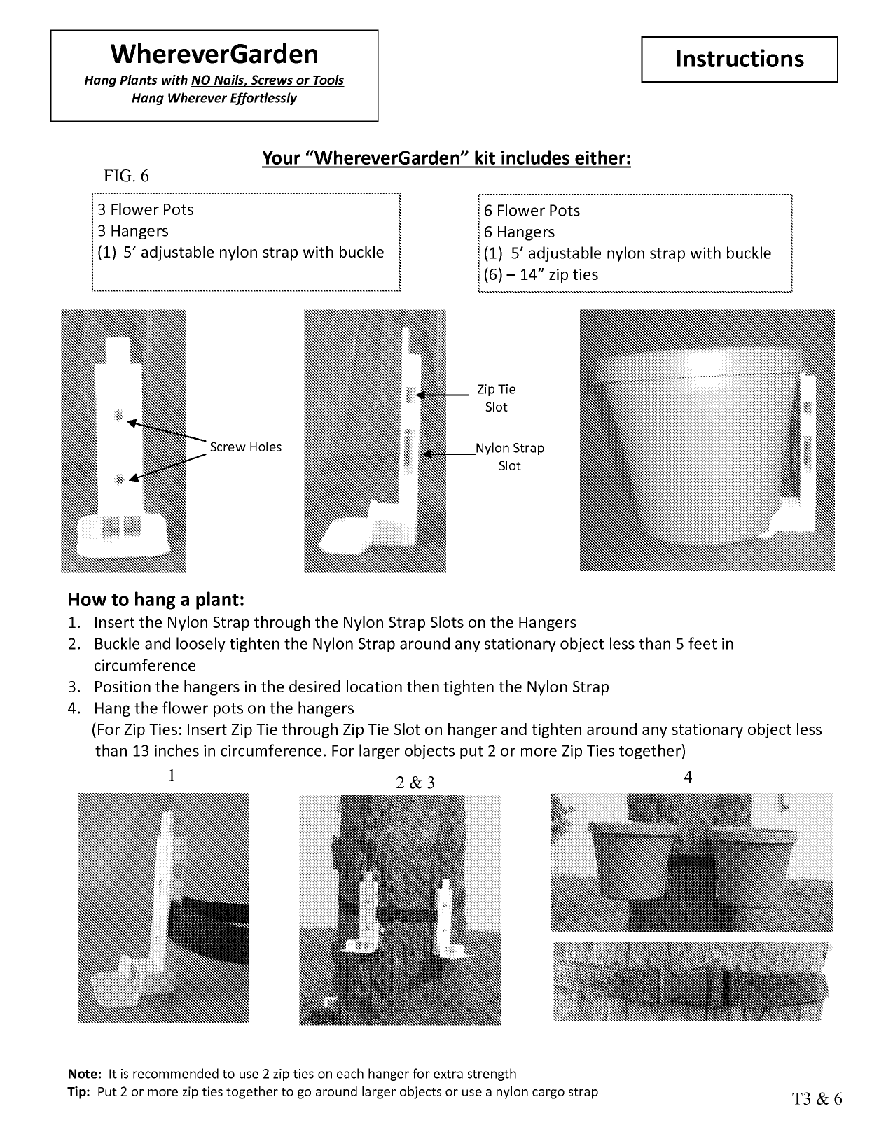

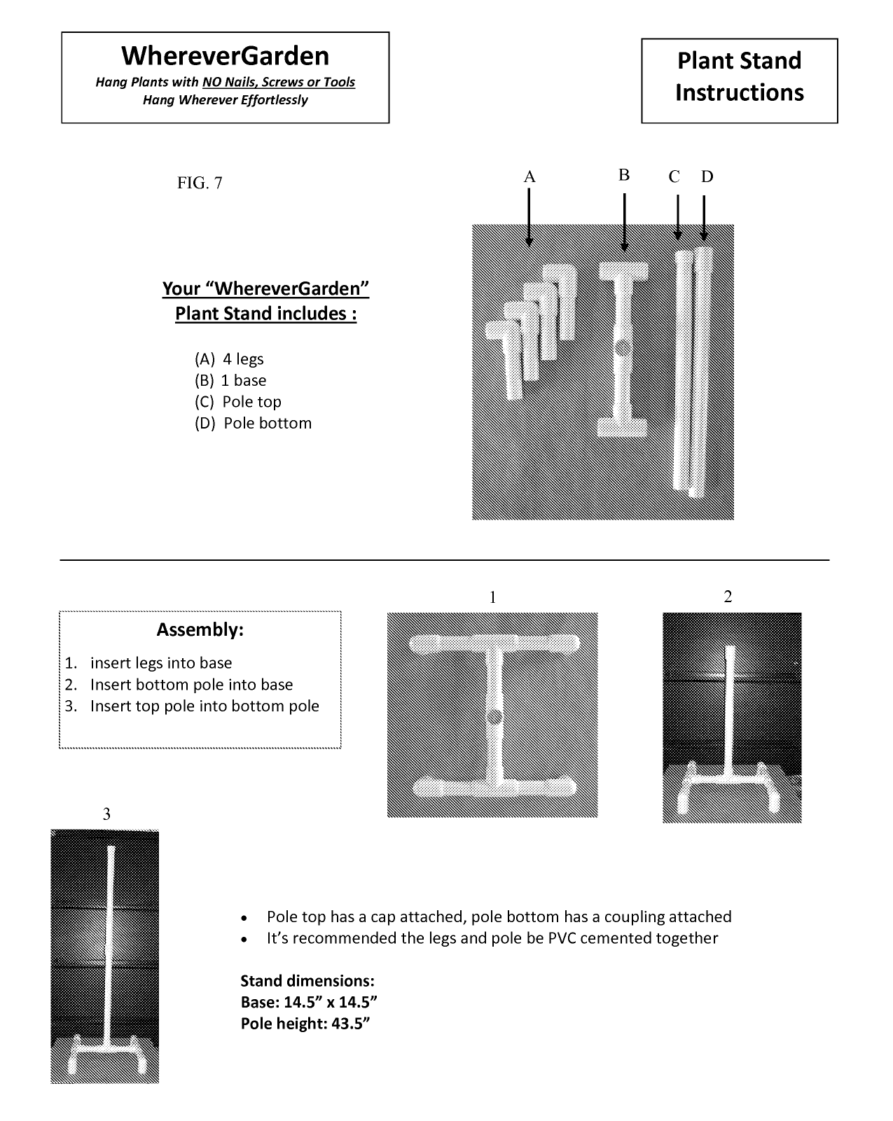

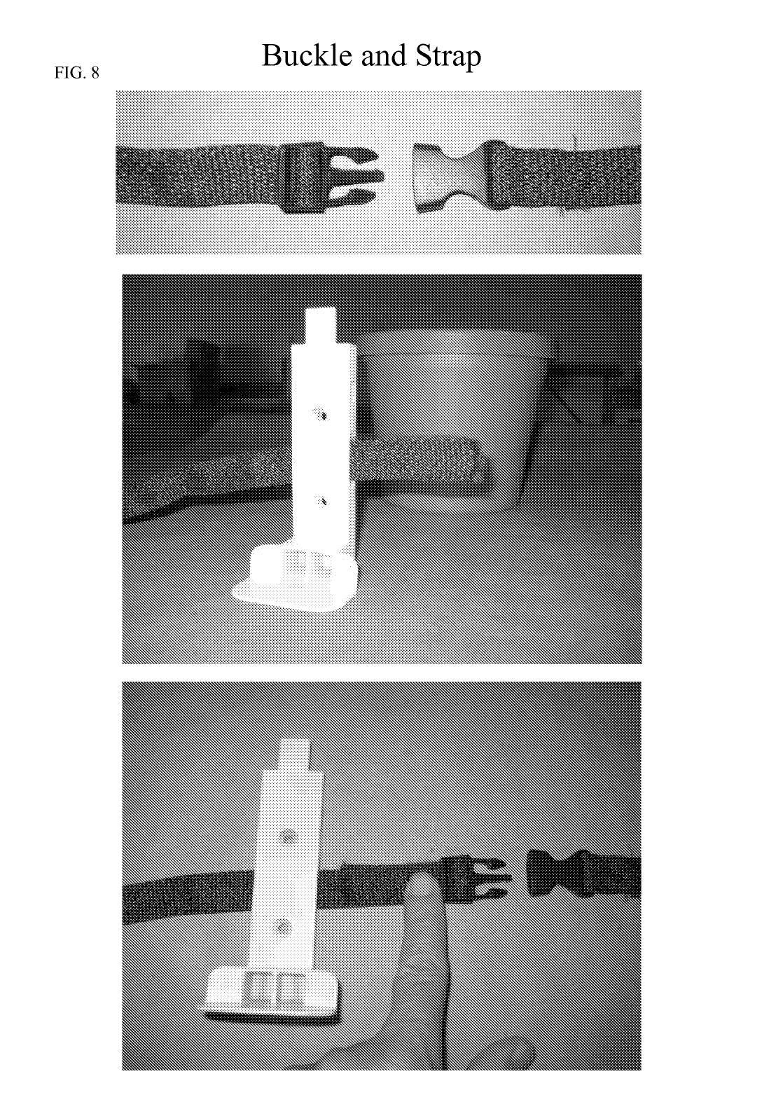

FIG. 4A presents an embodiment of the Wherever Garden System as applied to the trunk of a tree. A strip of material such as nylon or similar fabric is provided with a male-female insertion member/receiving member system 22. This strip is threaded within the back of the larger side to side perforation 5 within the side edges of the mounting device 1 as a user wraps the strip about a tree trunk. He or she then engages the insertion member/receiving member together leaving the mounting 1 device loaded onto a tree trunk or similar mounting pole, fence post etcetera. A planting pot or vase is then placed against the tree trunk using the mounting device 1 bottom support plate 13.

FIG. 4B presents an embodiment of the Wherever Garden System standalone system using a plastic tie 22 threaded through the smaller aperture in the side edges of the plant mounting device. The standalone planting system is assembled as shown in FIG. 3 and a mounting device 1 is utilized to mount a pot or vase. In this embodiment, a plastic tie is threaded within the back of the smaller side to side perforation 4 within the side edges of the mounting device 1 as a user wraps the strip about the central connecting member. He or she then engages the attachment by inserting the plastic tie head into the connecting hole within the tie strip and tightening it; this leaves the mounting 1 device loaded onto a central connecting member.

The following are the steps teaching a user how to hang a potted plant using a ZIP tie. In summary the steps are as follows: 1. Slid Zip Tie through Zip Tie slot 2. Tighten Zip Tie around any stationary object less than 13″ in circumference 3. Cut off the extra zip tie 4. Hang the flower pot on hanger. For larger objects put 2 or more Zip Ties together.

The following teaches a user how to hang a potted plant using a nylon strip and male female engagement members. It is presumed that a user has disengaged a nylon strip from a buckle insertion member IM. 1. Insert the Nylon Strap through the Nylon Strap Slots on the Hangers; 2. Buckle and loosely tighten the Nylon Strap around any stationary object less than 5 feet in circumference; 3. Position the hangers in the desired location then tighten the Nylon Strap; 4. Hang the flower pots on the hangers. It should be readily apparent that the nylon strip is wrapped around a transverse post in the body of the buckle and tightened accordingly.

Finally, in order to connect the nylon slip to the mounting device the following steps must be performed. First, the nylon strip in a buckle of the insertion member IM is removed from the transverse member within the square region of the buckle and slid out therefrom. Then, a user slides this through the back of the plant mounting device in the perforation for this purpose. The nylon strip is reinserted about the transverse strip in the buckle or square portion of the insertion member IM and then it is engaged with the receiving member RM.

Thus has been shown a simple easy to use system of mounting pots or vases on the side of trees, posts, or even a dedicated standalone mounting system. Thus a pot can be hung on a tree trunk, post, pole, railing, fence, balcony baluster, mail box post, etc. Also, because of the unique hanging system taught herein no Nails, Screws or Tools are needed to hang a flower pot. These overcome the deficiencies previously mentioned. Further, it should be understood that numerous modifications of the teachings herein are possible without departing from the spirit and scope of the invention that is defined from the accompanying claims. For example, the concave surface at the back surface 7 of the back member is extendible down the entire length of the back member and or expanded to have side to side extension; that is the concavity extends from the edge of side faces 4 to 5 rather than a portion thereof. Also, various cutouts formed in various views are finable with plastic material as needed or more cutouts can be added so as to provide flexibility in the amount of material used.

What is claimed is:

1. A planter mounting device comprising:
a back member integrated perpendicularly with
a support member having
an intermediate member and
a mounting plate such that the intermediate member connects the back member to the mounting plate.

2. The planter mounting device of claim 1, further comprising:
a first perforation from a side of the back member to another side of the back member.

3. The planter mounting device of claim 2, further comprising:
a second perforation from a side of the back member to another side of the back member.

4. The planter mounting device of claim 2, further comprising:
a first hole from a front surface of the back member to a back surface of the back member.

5. The planter mounting device of claim 4, further comprising:
a second hole from a front surface of the back member to a back surface of the back member.

6. The planter mounting device of claim 2, further comprising:
a first hole from a front surface of the back member to a back surface of the back member disposed underneath the first perforation.

7. The planter mounting device of claim 6, further comprising:
a second perforation from a side of the back member to another side of the back member disposed underneath the first hole.

8. The planter mounting device of claim 7, further comprising:
a second hole from a front surface of the back member to a back surface of the back member disposed underneath the second perforation.

9. The planter mounting device of claim 1, further comprising:
a tongue extending out from a top of the back member.

10. The planter mounting device of claim 1, wherein the junction between the mounting plate and the intermediate member comprises a curved surface.

11. The planter mounting device of claim 1, wherein the junction between the mounting plate and the intermediate member comprises a curved surface.

12. The planter mounting device of claim 1, wherein the mounting plate integrates with the intermediate member along an edge of the intermediate member that also forms a bottom edge of a curved surface disposed between the mounting plate and the intermediate member.

13. A planting system comprising:
a central T joint connected to
two connection members that are each in turn singly connected to
one of two T joints that are each connected to another connection member thus forming another four connection members that end in an elbow joint at the opposite side of each another four connection members.

14. A mounting system comprising:
a back member having
a front face
a back face
and two oppositely disposed side faces all integrally formed together wherein the back member has a first side face to side face perforation and is formed integrally with
a mount support therein.

15. The mounting system of claim 14, further comprising:
a second perforation from one side face to another disposed in the back member.

16. The mounting system of claim 14, wherein the mount support further comprises:
an intermediate member integral with the back member.

17. The mounting system of claim 16, wherein the mount support further comprises:
a mount plate integral with the intermediate member.

18. The mounting system of claim 16, wherein the mount support further comprises:
a back surface integral with and disposed between the mount plate and the intermediate member.

19. The mounting system of claim 14, wherein the mount support further comprises:
an back concave surface integral with the back member.

20. The mounting system of claim 14, wherein the mount support further comprises:
an mount plate integral with the back member.
